(19) United States
(12) Patent Application Publication
(10) Pub. No.: US 2026/0340441 A1
(43) Pub. Date: Oct. 29, 2026

(54) TASK- AND ROLE-CENTRIC KNOWLEDGE GRAPHS

(71) Applicant: Insight Direct USA, Inc., Chandler, AZ (US)

(72) Inventor: Michael Griffin, Wayland, MA (US)

(21) Appl. No.: 19/569,518

(22) Filed: Mar. 17, 2026

Related U.S. Application Data
(60) Provisional application No. 63/773,775, filed on Mar. 18, 2025.

(51) Int. Cl. G06N 5/022; G06Q 10/0631

(52) U.S. Cl. CPC G06N 5/022; G06Q 10/06316

(57) ABSTRACT

A method of automatedly extracting task-specific information from a knowledge base includes generating a plurality of metadata tags describing content of a plurality of documents using a first machine-learning language model, extracting at least one entity from each document of the plurality of documents (thereby extracting a plurality of entities), generating a plurality of relationships between the plurality of entities. The method further includes assembling a set of task-specific metadata tags, identifying task-specific documents of the plurality of documents using the task-specific metadata tags and the plurality of metadata tags, defining a subset of the plurality of entities extracted from the task-specific documents as task-relevant entities, retrieving a subset of relationships from the plurality of relationships, the subset of relationships connecting the task-relevant entities, and generating a task-specific knowledge graph based on the task-relevant entities and the subset of relationships.

### CROSS-REFERENCE TO RELATED APPLICATION

This application claims the benefit of U.S. Provisional Patent Application No. 63/773,775, filed Mar. 17, 2025, and entitled “TASK- AND ROLE-CENTRIC KNOWLEDGE GRAPHS,” the disclosure of which is hereby incorporated by reference in its entirety.

### FIELD OF THE INVENTION

The present disclosure relates to knowledge graphs, more particularly, systems and methods automated generation, retrieval, and use of task-specific knowledge graphs.

### BACKGROUND

Knowledge graphs are graph-structured models that represent the data of knowledge bases and enable the data of those knowledge bases to be examined and used for various tasks. Knowledge graphs organize data from multiple sources (e.g., files, documents, etc.) as nodes, representative of entities derived from those data sources, and edges, which are representative of relationships between the nodes. A knowledge graph thereby organizes and forms a data structure of the entities of a knowledge base (i.e., according to the relationships that structure the edges of the graph) and can be examined to understand, interrogate, etc. those entities.

### SUMMARY

An example of a method of task-specific language generation includes receiving a knowledge base containing a plurality of documents, generating a plurality of metadata tags describing content of a plurality of documents using a first machine-learning language model, extracting at least one entity from each document of the plurality of documents, thereby extracting a plurality of entities, generating a plurality of relationships between the plurality of entities, receiving a plurality of sets of task-specific metadata tags, generating a plurality of task-specific knowledge graphs and a plurality of corresponding subsets of metadata tags. The plurality of task-specific knowledge graphs and the plurality of corresponding subsets of metadata tags are generated by, for each set of task-specific metadata tags, identifying task-specific documents of the plurality of documents using the set of task-specific metadata tags and the plurality of metadata tags, retrieving a subset of entities of the plurality of entities extracted from the task-specific documents, retrieving a subset of relationships from the plurality of relationships, generating one task-specific knowledge graph based on the subset of entities and the subset of relationships, and generating one subset of metadata tags of the plurality of subset of metadata tags. The subset of relationships connects the subset of entities and the one subset of metadata tags including all metadata tags of the plurality of metadata tags derived from the task-specific documents. The method further includes storing the plurality of task-specific knowledge graphs and the plurality of subsets of metadata tags to a knowledge graph database, receiving a set of query tags based on a description of a new task, querying the knowledge graph database with the set of query tags to identify a task-relevant knowledge graph of the plurality of knowledge graphs, retrieving relevant documents of the plurality of documents by interrogating the relevant knowledge graph with the description of the new task, and generating a written plan for performing the new task using a task-handling machine-learning model and based on the relevant documents and the description of the new task.

An example of a method of automatedly extracting task-specific information from a knowledge base includes generating a plurality of metadata tags describing content of a plurality of documents using a first machine-learning language model, extracting at least one entity from each document of the plurality of documents (thereby extracting a plurality of entities), generating a plurality of relationships between the plurality of entities. The method further includes assembling a set of task-specific metadata tags, identifying task-specific documents of the plurality of documents using the task-specific metadata tags and the plurality of metadata tags, defining a subset of the plurality of entities extracted from the task-specific documents as task-relevant entities, retrieving a subset of relationships from the plurality of relationships, the subset of relationships connecting the task-relevant entities, and generating a task-specific knowledge graph based on the task-relevant entities and the subset of relationships.

An example of a system for automatedly extracting task-specific information from a knowledge base includes a processor and at least one memory encoded with instructions. The instructions, when executed, cause the processor to generate a plurality of metadata tags describing content of a plurality of documents using a first machine-learning language model, extract at least one entity from each document of the plurality of documents (thereby extracting a plurality of entities), and generate a plurality of relationships between the plurality of entities. The instructions, when executed, further cause the processor to assemble a set of task-specific metadata tags, identify task-specific documents of the plurality of documents using the task-specific metadata tags and the plurality of metadata tags, define a subset of the plurality of entities extracted from the task-specific documents as task-relevant entities, retrieve a subset of relationships from the plurality of relationships, the subset of relationships connecting the task-relevant entities, and generate a task-specific knowledge graph based on the task-relevant entities and the subset of relationships.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for automated generation of task- and role-specific knowledge graphs, as well as the retrieval and use of those knowledge graphs

FIG. 2 is a schematic diagram of a further example of a system for automated generation of task- and role-specific knowledge graphs, as well as the retrieval and use of those knowledge graphs

FIG. 3 is a flow diagram of an example of a method of automated generation of task- and role-specific knowledge graphs, and, further, of the use of task- and role-specific knowledge graphs for language generation.

FIG. 4 is a flow diagram of a further example of a method of automated generation of task- and role-specific knowledge graphs, and, further, of the use of task- and role-specific knowledge graphs for language generation.

FIG. 5 is a flow diagram of yet a further example of a method of automated generation of task- and role-specific knowledge graphs, and, further, of the use of task- and role-specific knowledge graphs for language generation.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for generation, retrieval, and use of task-specific knowledge graphs. The task-specific knowledge graphs herein are tailored to a particular work task using metadata information generated by machine-learning language models and advantageously limit the information organized by each knowledge graph to the information that is relevant to a particular task, reducing computational and labor costs associated with use of the task-specific knowledge graphs as compared to existing methods and systems. Further, the knowledge graphs generated by the systems and methods herein reduce the labor required to perform particular tasks and, further, reduce the likelihood of worker knowledge gaps that can reduce productivity and cause errors, among other undesirable outcomes.

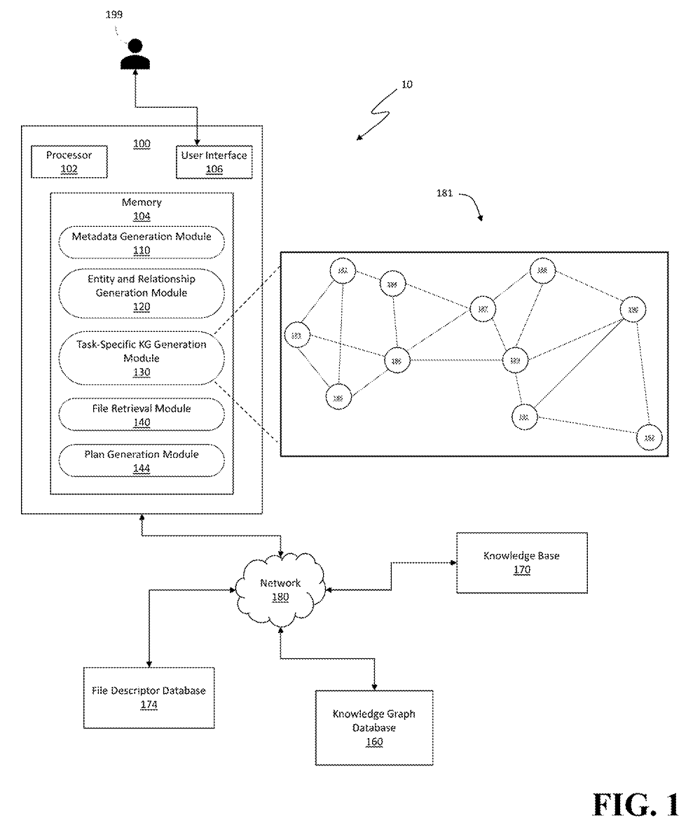

FIG. 1 is a schematic depiction of system 10, which is a system for automated generation of task- and role-specific knowledge graphs, as well as the retrieval and use of those knowledge graphs. System 10 includes server 100, knowledge graph database 160, knowledge base 170, file descriptor database 174, and network 180. Server 100 includes processor 102, memory 104, and user interface 106. Memory 104 stores metadata generation module 110, entity and relationship generation module 120, task-specific knowledge graph generation module 130, file retrieval module 140, and plan generation module 144. FIG. 1 also depicts user 198 and relationship graph 181.

Server 100 is configured to automatedly generate task- and role-specific knowledge graphs. The knowledge graphs of the present disclosure include nodes that represent entities derived from a knowledge base (e.g., knowledge base 170) and that are connected by edges representing relationships between those entities and/or between the underlying documents and/or files from which those entities are derived. The knowledge graphs generated by server 100 can be provided to human workers to enable those workers to more quickly perform a task or other role-specific functions. The knowledge graphs generated by server 100 can also be used to enhance language generation by machine-learning language models.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. Memory 104, in one example, is used by software or applications running on server 100 (e.g., by a computer-implemented machine-learning model) to temporarily store information during program execution.

Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

Knowledge graph database 160 is an electronic database that is connected to server 100 via network 180. Knowledge graph database 160 stores task-specific knowledge graphs generated by the programs of server 100. Knowledge graphs for particular tasks and/or for particular roles can be pre-generated by server 100 and stored to knowledge graph database 160. Each knowledge graph stored to knowledge graph database 160 is associated with metadata for topics, documents, etc. represented by the knowledge graph, and metadata information for a new task can be used to query knowledge graph database 160 to retrieve a relevant knowledge graph. Knowledge graph database can be, for example, a structured database (e.g., a table or relational database), a semi-structured database (e.g., a hierarchical and/or nested database), and/or an unstructured database, but is generally configured to be queried by server 100.

Knowledge base 170 is a knowledge base and/or knowledge source that is communicatively connected to server 100 via network 180. Knowledge base 170 stores information used by a business or other suitable organization that operates and/or uses server 100 and knowledge base 170. The information stored by knowledge base 170 is used by workers of the business or organization to perform work-related tasks. Knowledge base 170 can store information in any suitable manner. In at least some examples, knowledge base 170 is or includes a file system that organizes various text and other files that are accessed by users to perform work-related tasks. In these examples, knowledge base 170 can include one or more file servers to organize any suitable number of files. As a specific example, knowledge base 170 can include text documents, portable document format files, and image files that are referenced by workers of the business that operates knowledge base 170. Additionally and/or alternatively, knowledge base 170 can include one or more databases and/or tables for organizing data accessed by workers to perform work-related tasks.

File descriptor database 174 is a database connected to server 100 via network 180. File descriptor database stores metadata tags describing file segments of the files of knowledge base 170, as well as entities extracted from those file segments and relationships between those entities. Metadata tags generated by metadata generation module 110 and entity and relationship information generated by entity and relationship generation module 120 can be stored to file descriptor database 174 and retrieved for use with task-specific knowledge graph generation module 130 to create task-specific knowledge graphs. File descriptor database 174 can also store an address, location, or other suitable information defining the file segment so that the file segment can also be retrieved using the information stored and organized by file descriptor database 174.

Network 180 is a network suitable for connecting and facilitating network communication between two or more of server 100, error-function database 150, and raw data base 170. Network 180 can include any suitable combination of local area network (LAN) and wide area network (WAN) elements or components to facilitate communication between two or more of server 100, error-function database 150, and raw data base 170. In some examples, network 180 can be or include the Internet.

Relationship graph 181 is one example of a relationship graph that can be created by task-specific knowledge graph generation module 130. Relationship graph 181 can be stored to knowledge graph database 160 and can be retrieved by file retrieval module 140 and used to identify documents, files, etc. that are relevant to a particular task, as will be described in more detail subsequently. Relationship graph 181 includes nodes 182–192, which are connected by various edges. Node 182 is connected to nodes 183, 184, and 185. Node 183 is connected to nodes 183, 185, and 186. Node 184 is connected to nodes 182, 186, and 187. Node 185 is connected to nodes 182, 183, and 186. Node 186 is connected to nodes 183, 184, 185, 187, and 189. Node 187 is connected to nodes 184, 186, 18, and 189. Node 188 is connected to nodes 187, 189, and 190. Node 189 is connected to nodes 186, 187, 188, 190, and 191. Node 190 is connected to nodes 188, 189, 191, and 192. Node 191 is connected to nodes 189, 190, and 192. Node 192 is connected to nodes 190 and 191. Relationship graph 181 is an example of a visual, plotted depiction of relationship graph information. The information depicted in relationship graph 200 can be stored in other manners (e.g., as a table, array, or database). The plotted depictions of relationship graphs herein are not limiting and are included for explanatory purposes.

Metadata generation module 110 is a software module of server 100 and includes one or more programs for generating metadata tags that can be used to create task-specific knowledge graphs according to the present disclosure. Metadata generation module 110 uses one or more machine-learning language models to generate text representative of task or task elements to which a file segment of knowledge base 170 relates. Metadata generation module 110 can generate one or more metadata tags for each file segment derived from the files of knowledge base 170. These file-specific metadata tags are stored to file descriptor database 174. In examples where the files of knowledge base 170 are referred to as “documents,” file-specific metadata tags as described herein can be referred to as “document-specific metadata tags.”

Metadata generation module 110 can also generate task-specific metadata tags for a particular task. These task-specific metadata tags can be used to search file descriptor database 170 to identity task-relevant files of knowledge base 170 and, further, to generate task-specific knowledge graphs based on the entities and relationships generated (i.e., by entity and relationship generation module 120) for those task-relevant files.

In at least some examples, metadata generation module 110 generates file-specific and task-specific metadata tags using a common set of metadata categories. Metadata generation module 110 can provide the categories in a prompt for the machine-learning model containing the request to generate the metadata tags. The categories can be any suitable category and are generally selected according to the tasks performed by workers of a business organization operating and/or using system 10. For example, if the business organization operation system 10 is an automotive insurance provider, the metadata categories can include one or more of an accident or claim type (e.g., at fault, no fault, dram shop, etc.), a jurisdiction (e.g., a state in which an accident occurred), and a relevant law (e.g., relevant to a claim or matter discussed in semantic text of the file), among other options. Other options for metadata categories are possible and the aforementioned example is merely one exemplary embodiment included for illustrative purposes.

Metadata generation module 110 or another suitable program of system 10 can also generate file segments from the files of knowledge base 170. As referred to herein, a “file segment” can be any suitable portion of a file and, in some examples, can be an entire file of knowledge base 170. The file segments can be a set size, such as a set number of words or characters from a document file. The use of file segments rather than whole files with the programs of server 100 is optional but can advantageously reduce the computational cost associated with processing of files by metadata generation module 110 and entity and relationship generation module 120, and further can improve task relevance of knowledge graphs created by task-specific knowledge graph generation module 130. The file segments can be used in place of full, unsegmented files to generate entity and relationship information (i.e., using entity and relationship generation module 120), and each file segment can be assigned metadata derived from the respective parent (i.e., unsegmented) file from which the file segment was derived.

The machine-learning language model used by metadata generation module 110 can be any suitable machine-learning model for generating natural-language outputs from natural-language inputs. In at least some examples, the machine-learning language model can be a transformer model, such as a Large Language Model Meta AI (LLaMA) model or a Generative Pre-trained Transformer (GPT) model.

Entity and relationship generation module 120 is another software module of server 100 and includes one or more programs for extracting entity and relationship information from files and/or file segments. The entity and relationship information generated by entity and relationship generation module 120 is usable by task-specific knowledge graph generation module 130 to generate knowledge graphs. Entity extraction can be determined using a machine-learning language model, such as a natural-language processing (NLP) model or another suitable model for extracting entity information. Any suitable number of entities describing any suitable topics, properties, etc. can be generated by semantic text data contained within a given file or file segment.

Entity and relationship generation module 120 also generates relationships that can be used to relate the extracted entities. Entity relationships can be based using any suitable technique, such as dependency parsing, co-occurrence analysis, etc. In other examples, relationships between files and/or file segments can be determined according to a vector analysis, and the relationships between files and/or file segments can be applied to the entities extracted therefrom. Each file and/or file segment can be vectorized using a suitable vectorization algorithm, and vector comparison can be performed. Files and/or file segments having sufficiently similar (e.g., a similarity score above a particular threshold) can be related. In these examples, vector comparison can be performed using any suitable technique, such as cosine similarity, Manhattan distance, Euclidian distance, dot product similarity, etc.

Task-specific knowledge graph generation module 130 is a further software module of server 100 and includes one or more programs for generating task-specific knowledge graphs. The program(s) of task-specific knowledge graph generation module 130 are able to query file descriptor database 174 using a set of task-specific metadata tags generated from a description of a given task (i.e., by metadata generation module 110). Based on the query, the program(s) task-specific knowledge graph generation module 130 retrieve files and/or file segments that are task-relevant, according to their shared or similar metadata tags. The program(s) of task-specific knowledge graph generation module 130 can then build a knowledge graph based on the entities previously extracted from the files and/or file segments as well as the relationships previously generated for the entities of the files and/or file segments. As described previously, both the entity and relationship information can be pre-generated by entity and relationship generation module 120 and stored to file descriptor database 174, and can also be retrieved by the query with the task-specific metadata tags.

Task-specific knowledge graphs can be pre-generated and stored to knowledge graph database 160. The metadata tags used to generate a task-specific knowledge graph or another suitable text phrase descriptive of the knowledge graph can be associated with the task-specific knowledge graph in knowledge graph database 160. In some examples, task-specific knowledge graphs can be generated at a regular time interval, such that knowledge graph database 160 only stores knowledge graphs desired to be used and/or likely to be used within the time period defined by the regular time interval. In some of these examples, knowledge graphs can be generated based on the tasks expected to be performed during the time period. As a specific example, task-specific knowledge graph generation module 130 can be configured to update knowledge graph database 160 once per day (e.g., nightly). Optionally, task-specific knowledge graph generation module 130 can be configured to only generate and store knowledge graphs for tasks expected to be performed during the next workday, such that knowledge graph database 160 only stores knowledge graphs for tasks expected to be performed in a single workday.

File retrieval module 140 is another software module of server 100 and includes one or more programs for interrogating knowledge graphs and retrieving relevant documents. The program(s) of file retrieval module 140 can receive a user query and/or a prompt for language generation and can interrogate a knowledge graph to identify relevant files and/or file segments. In some examples, file retrieval module 140 can also retrieve an appropriate knowledge graph by query knowledge graph database 160 (e.g., with metadata tags for a task).

Plan generation module 144 is yet a further software module of server 100 and includes one or more programs for generating a written plan for performing a task. Plan generation module 144 is an optional module of server 100 and is included in examples where it is desirable to generate a written plan for solving a task. Plan generation module 144 can retrieve a task-specific knowledge graph based on metadata tags for a particular task. Optionally, plan generation module 144 can generate the metadata tags using the programs of metadata generation module 110.

Plan generation module 144 can then provide the task description as well as the task-specific knowledge graph to file retrieval module 140 to retrieve relevant files and/or file segments. Plan generation module 144 can then generate an augmented prompt containing the retrieved files and/or file segments. Plan generation module 144 and/or file retrieval module 140 can use any suitable method for retrieving relevant files and generating an augmented prompt, and, in at least some examples, can use a graph retrieval augmented generation (GraphRAG) approach. Plan generation module 144 can then provide the augmented prompt as an input to a machine-learning language model, such as the machine-learning language model used for metadata generation or another suitable machine-learning language model. The augmented prompt includes a request that the machine-learning language model generate a written plan for performing the task based, at least in part, on the retrieved files and/or file segments. The resultant output can be provided to a user as the written plan for performing the task.

In some examples, system 10 can be configured to process the files of knowledge base 170 at regular intervals (e.g., nightly) to update file descriptor database 174. Where system 10 includes knowledge graph database 160 and pre-generates task-specific knowledge graphs (i.e., that are stored to knowledge graph database 160), system 10 can also update the knowledge graphs stored to knowledge graph database 160 at the same interval using the updated file descriptor database 174.

The modules of server 100 are shown as separate software components in FIG. 1 for explanatory clarity and convenience. In other examples, any two or more of metadata generation module 110, entity and relationship generation module 120, task-specific knowledge graph generation module 130, file retrieval module 140, and plan generation module 144 can be part of a single software program and/or application. Similarly, server 100, knowledge graph database 160, knowledge base 170, and file descriptor database 174 are depicted as single devices in FIG. 1 for explanatory convenience. In other examples, any two or more of server 100, knowledge graph database 160, knowledge base 170, and file descriptor database 174 can be distributed across and/or integrated into any suitable number of physical and/or virtual devices.

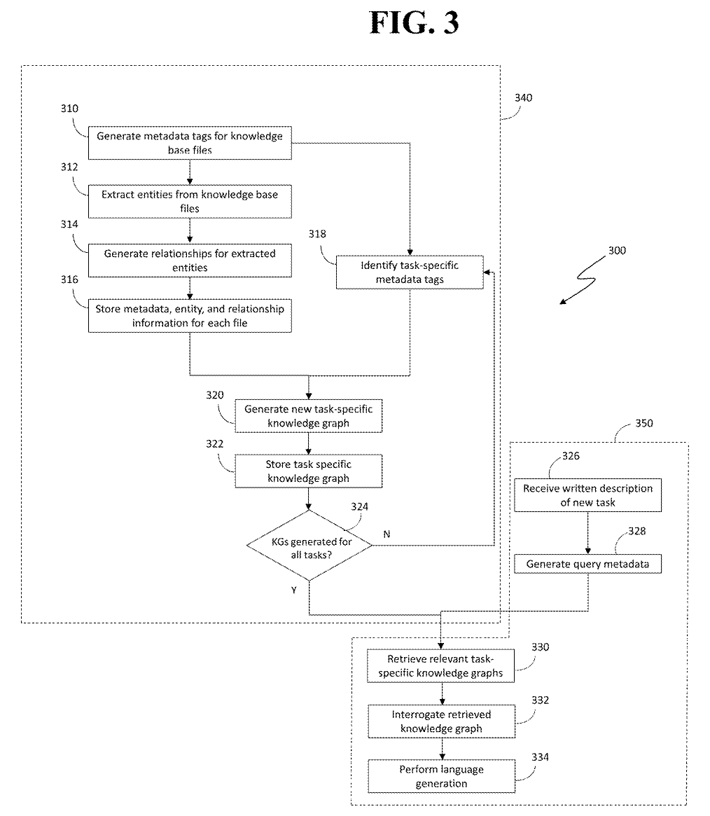

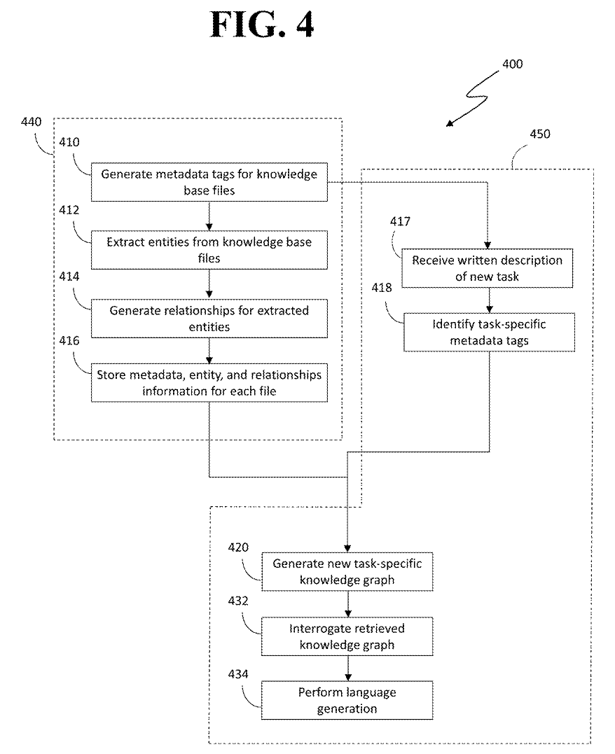

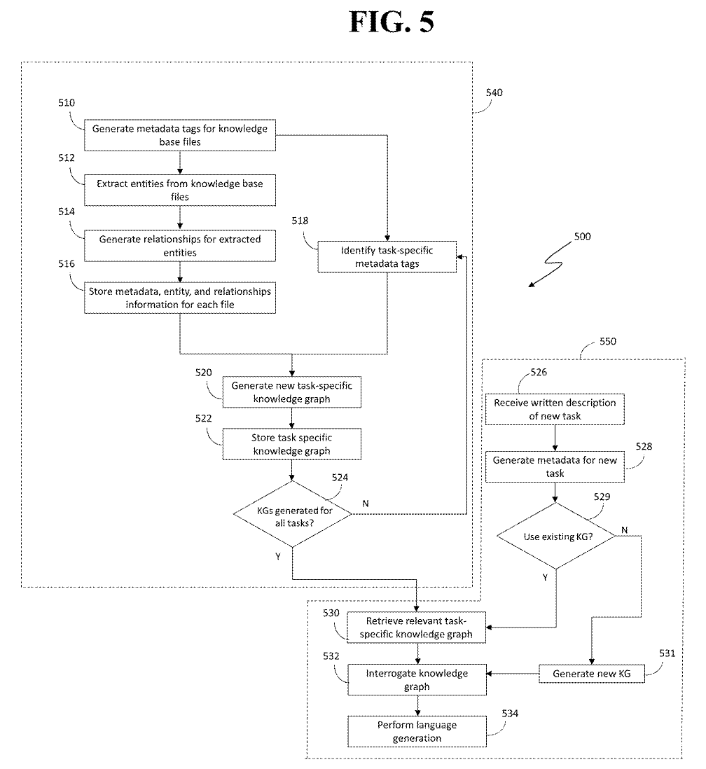

Advantageously, system 10 enables automated generation and use of task-specific knowledge graphs, as will be explained in more detail subsequently with respect to the discussion of method 300 (FIG. 3), method 400 (FIG. 4), and method 500 (FIG. 5). In particular, the task-specific knowledge graphs of system 10 organize disparate data sources of knowledge base 170 into discrete representations of the topics and files relevant to a particular task. In existing business organizations, the locations and identities of many specific, task-relevant files are not documented and are known only to particular workers. The large size of knowledge bases (often many thousands of files) prevents workers from easily identifying relevant files without training or other prior knowledge. This often leads to knowledge gaps that are only resolved by time-intensive training processes by workers with knowledge of the identities and locations of these task-relevant files. Notably, this time-intensive training process must be repeated for each task performed by a worker. Furthermore, if a knowledge gap is not known to a worker, that worker may make mistakes that are detrimental to the operation of the business employing the worker. System 10 provides automated generation of knowledge graphs that provide the identities and locations of files relevant to business tasks, and, further, enables the automated identification and retrieval of a knowledge graph relevant to a particular task that is to be performed by a particular worker based only on a written description of the task. As such, system 10 provides an automated solution for closing worker knowledge gaps without requiring time-intensive, manual training led by more experienced workers.

Further, existing systems and methods do not enable the creation of task-specific knowledge graphs. Consequently, existing methods and systems produce knowledge graphs that usually contain irrelevant information to a particular task and/or information relevant to a large number of tasks. For example, a knowledge graph based on as few as 20 documents may have many hundreds or thousands of nodes connected by various edges. A knowledge graph describing the documents of a typical knowledge base (i.e., thousands of documents) would have a sufficiently large number of nodes to be unusable for document retrieval by manual (i.e., via a human operator) or automated (e.g., via automated interrogation for GraphRAG) means. As such, the task-specific knowledge graphs generated by system 10 according to, e.g., method 300 (FIG. 3), method 400 (FIG. 4), and method 500 (FIG. 5) advantageously limit the nodes of a particular knowledge graph by limiting the files represented by the knowledge graph to a subset of files relevant to a particular task. Further, system 10 advantageously allows task-relevant files to be identified in an automated manner and without manual identification of task-relevant documents by a user.

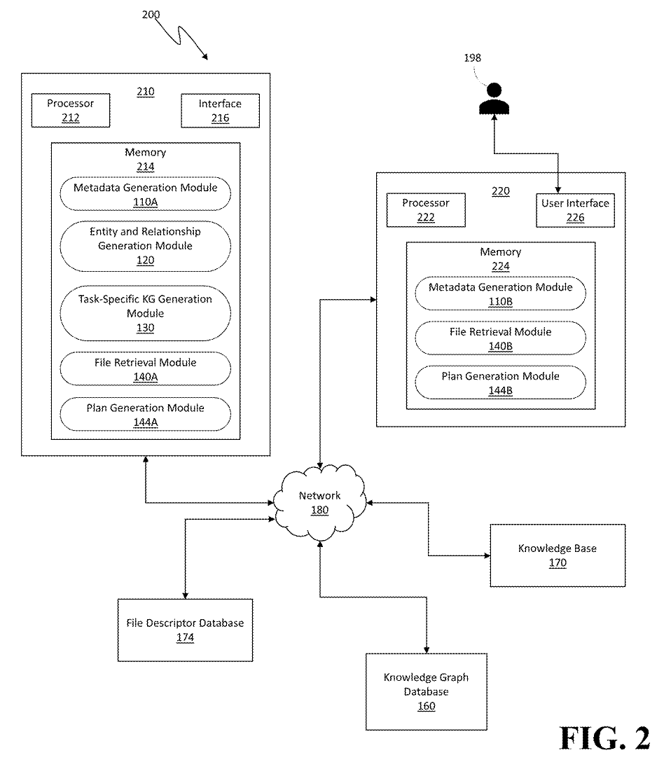

FIG. 2 is a schematic diagram of system 200, which is a further example of a system for automated generation of task- and role-specific knowledge graphs, as well as the retrieval and use of those knowledge graphs. System 200 is one example of a system in which the functionality of server 100 is distributed across multiple computing devices. System 200 includes graph generation server 210, user device 220, knowledge graph database 160, knowledge base 170, file descriptor database 174, and network 180. Graph generation server 210 includes processor 212, memory 214, and interface 216. User device 220 includes processor 222, memory 224, and user interface 226. Memory 214 stores metadata generation module 110A, entity and relationship generation module 120, task-specific knowledge graph generation module 130, file retrieval module 140A, and plan generation module 144A. Memory 224 stores metadata generation module 110B, file retrieval module 140B, and plan generation module 144B. FIG. 2 also depicts user 198.

System 200 is substantially similar to system 10 (FIG. 1) but includes two computing devices, graph generation server 210 and user device 220, that collectively perform the functionality of server 100 of system 10. System 200 can optionally include only one module of any of the duplicate pairs of modules of system 200 (i.e., only one of the pair of metadata generation module 110A and metadata generation module 110B, only one of file retrieval module 140A and file retrieval module 140B, and/or only one of plan generation module 144A and plan generation module 144B). In at least some examples, system 200 includes all modules depicted in FIG. 2.

In system 200, graph generation server 210 generates knowledge graphs that can be optionally interrogated and used for language generation by graph generation server 210 and/or user device 220. Further, graph generation server 210 and/or user device 220 can collect task descriptions and generate task-specific metadata for knowledge graph generation.

FIG. 3 is a flow diagram of method 300, which is a method of automated generation of task- and role-specific knowledge graphs, and, optionally, of the use of task- and role-specific knowledge graphs for language generation. Method 300 includes steps 310–334 of generating metadata tags for knowledge base files (step 310), extracting entities from knowledge base files (step 312), generating relationships for the extracted entities (step 314), storing metadata, entity, and relationship information for each file (step 316), identifying task-specific metadata tags (step 318), generating a new task-specific knowledge graph (step 320), storing the task specific knowledge graph (step 322), determining whether knowledge graphs have been generated for all tasks (step 324), receiving a written description of a new task (step 326), generating query metadata (step 328), retrieving a relevant task-specific knowledge graph (step 330), interrogating the retrieved knowledge graph (step 332), and performing language generation (step 334). Method 300 is discussed generally herein with reference to system 10 (FIG. 1) for clarity and explanatory convenience, but can be performed by any suitable system, including, e.g., system 200 (FIG. 2). Steps 310–324 collectively form graph generation steps 340. Similarly, steps 326–334 collectively form graph retrieval steps 350.

In step 310, server 100 generates metadata tags for the files of knowledge base 170. The metadata tags can be generated for a given file, for example, prompting a machine-learning language model (e.g., a transformer model, as discussed previously) to generate tags descriptive of the file. The prompt can request that the machine-learning language model generate metadata tags according to pre-defined metadata tag categories (e.g., insurance claim type, jurisdiction, etc.).

In step 312, server 100 extracts entities from the files of knowledge base 170. Prior to step 312, server 100 can segment the files of knowledge base 170 into segments (e.g., separate documents into “chunk” or subsegments of the original documents). In these examples, server 100 uses the file segments to perform steps 312–314 and 332–334 in substantially the same manner as described herein with respect to entire files. Entity extraction can be performed using any suitable manner and, in at least some examples, is performed using a NLP algorithm. The entities describe or are key elements of text within each file. In some examples, entity extraction in step 312 can be performed using a named entity recognition (NER) method.

In step 314, server 100 generates relationships for the entities extracted from the files of knowledge base 170. Relationships can be generated using any suitable method, such as dependency parsing, co-occurrence analysis, etc. In other examples, relationships between entities can be determined according to vector analysis of the files and/or file segments from which those entities are derived. Each file can be vectorized using a suitable vectorization algorithm, and vector comparison can be performed. Files that are sufficiently similar (e.g., having a similarity score above a particular threshold) can be related. In these examples, vector comparison can be performed using any suitable technique, such as cosine similarity, Manhattan distance, Euclidian distance, dot product similarity, etc. The relationships can then be applied to entities extracted from sufficiently similar files.

In step 316, the metadata information generated in step 310, the entity information generated in step 312, and the relationship information generated in step 314 is stored to file descriptor database 174. The metadata, entity, and relationship information for each file is associated with the file (e.g., with a pointer, address, etc.).

In step 318, task-specific metadata tags for a given task are generated. The task-specific metadata tags can be generated in substantially the same manner as described with respect to step 310, but are generated using a natural-language description of a task performed by a business entity operating system 10 rather than the natural-language text of a file of knowledge base 170.

In step 320, task-specific knowledge graph generation module 130 generates a knowledge graph specific to the task used to generate metadata tags in step 318. The metadata tags generated in step 318 are used to query file descriptor database 174 to retrieve files having sufficiently similar metadata tags. Tag similarity can be assessed using any suitable method and, in at least some examples, is determined by vector similarity, as described previously. Task-specific knowledge graph generation module 130 then generates a knowledge graph that relates the entities for the retrieved files according to the entity and relationship information stored to file descriptor database 174.

In step 322, the task-specific knowledge graph is stored to knowledge graph database 160. The metadata tags generated in step 318 are associated with the task-specific knowledge graph, such that the knowledge graph is retrievable using the metadata tags used to create the knowledge graph.

In step 324, server 100 checks if knowledge graphs have been generated for all tasks. If task-specific knowledge graphs have not been generated for any tasks, method 300 proceeds to step 318 to generate task-specific knowledge graphs according to steps 318–320 until task-specific knowledge graph have been generated for all tasks. Once task specific knowledge graphs have been generated for all tasks, method 300 proceeds to step 330.

In step 326, a written description of a new task is received. The written description can be of any suitable length, format, etc.

In step 328, query metadata is generated. The query metadata can be generated by metadata generation module 110 in substantially the same manner as described previously with respect to step 310, but based on the description received in step 326.

In step 330, knowledge graph database 160 is queried using the metadata generated in step 328. Knowledge graph database 330 can be queried in any suitable manner and a relevant knowledge graph can be retrieved based on, e.g., metadata tag similarity. Tag similarity can be evaluated using, e.g., vector similarity, as described previously herein.

In step 332, the knowledge graph is interrogated using the description of the task received in step 326 to identify files relevant to the described task.

In step 334, language generation is performed. The language generation is performed by a machine-learning language model and based on a prompt containing the written task description (i.e., received in step 326), text of the files identified in step 332, and an instruction to generate a written plan for performing the task. In response to receiving the prompt, the machine-learning language model generates an output that can be provided to a user (e.g., user 198) and can be used by that user to perform the task.

Step 332 and 334 are optional steps of method 300 and of graph retrieval steps 350. In some examples, method 300 stops after step 330 and only the relevant knowledge graph is provided to the user. The user can then interact with the knowledge graph (e.g., with a visual depiction thereof) to identify files relevant to performing the task. File permissions (i.e., in examples where knowledge base 170 is permissioned) can be assigned based on the files represented by the knowledge graph. That is, where the user is able to manually retrieve files based on the knowledge graph provided in step 330, server 100 and/or knowledge base 170 can automatically modify user permissions to enable the user to access all files represented by the knowledge graph and, optionally, to restrict the user from accessing the other files of knowledge base 170.

Graph generation steps 340 can be performed periodically and, in some examples, on a regular interval (i.e., on a nightly basis) to update knowledge graph database 160 based on the current contents of knowledge base 170. Advantageously, this can allow server 100 to perform the relatively computationally-expensive tasks of pre-processing (i.e., metadata tag generation, entity extraction, relationship generation) for each file of knowledge base 170 and, further, of knowledge graph generation during non-working hours. The relatively less computationally-expensive tasks of graph retrieval steps 350 can then be performed during working hours to identify relevant knowledge graphs and, optionally, generate text using a machine-learning model (e.g., via GraphRAG).

Advantageously, method 300 enables the automated generation of a library of knowledge graphs that can be retrieved on-demand to perform particular worker tasks. A worker can provide a description of a task they are performing and/or server 100 can automatedly retrieve a description of a task to be performed by a worker, and server 100 can retrieve a knowledge graph that can aid the worker in performing the task. Optionally, method 300 also automatedly retrieves relevant documents based on the written description and can also generate instructions for performing the task based on the retrieved documents, further reducing the human labor associated with performing the task.

FIG. 4 is a flow diagram of method 400, which is another example of a method of automated generation of task- and role-specific knowledge graphs, and, optionally, of the use of task- and role-specific knowledge graphs for language generation. Method 400 includes steps 410–434 of generating metadata tags for knowledge base files (step 410), extracting entities from knowledge base files (step 412), generating relationships for the extracted entities (step 414), storing metadata, entity, and relationship information for each file (step 416), receiving a written description of a new task (step 417), identifying task-specific metadata tags (step 418), generating a new task-specific knowledge graph (step 420), interrogating the knowledge graph (step 432), and performing language generation (step 434). Method 400 is discussed generally herein with reference to system 10 (FIG. 1) for clarity and explanatory convenience, but can be performed by any suitable system, including, e.g., system 200 (FIG. 2). Steps 410–416 collectively form graph pre-generation steps 340. Similarly, steps 417–434 collectively form graph generation steps 450.

Method 400 is similar to method 300, except that method 400 does not pre-generate knowledge graphs and instead generates knowledge graphs on-demand and based on new task-specific metadata tags.

Steps 410, 412, 414, and 416 are substantially similar to steps 310, 312, 314, and 316 of method 300 (FIG. 3), respectively, and the discussion of steps 310, 312, 314, and 316 of method 300 is applicable to steps 410, 412, 414, and 416 of method 400, respectively. Step 417 is substantially similar to step 326 of method 300 and the description of step 326 is applicable to step 417 of method 400. Step 418 is substantially similar to step 318 of method 300, except that the task-specific metadata tags are generated based on the description received in step 417. Step 420 is substantially similar to step 320 of method 300, and the description of step 320 is applicable to step 420. Further, steps 432 and 434 are substantially similar to steps 322 and 324 of method 300, respectively, and the description of steps 322 and 324 are applicable to steps 432 and 434, respectively.

In method 400, metadata, entity, and relationship information is generated for each file of knowledge base 170 via steps 410–416 (i.e., graph pre-generation steps 340). This metadata, entity, and relationship information is then used to build on-demand knowledge graphs via steps 417–420. The knowledge graph can then be provided to a user (i.e., in examples of method 400 omitting or skipping steps 432–434). The knowledge graph can also be used to provide task-relevant files (i.e., via step 432) and language generation using the retrieved files can optionally be performed via step 434.

Method 400 advantageously does not require pre-generation of knowledge graphs, and instead delays computationally-expensive knowledge graph generation until server 100 is provided with a written description of a new task to be performed by a worker at a business organization operating server 100.

FIG. 5 is a flow diagram of method 500, which is yet a further example of a method of automated generation of task- and role-specific knowledge graphs, and, optionally, of the use of task- and role-specific knowledge graphs for language generation. Method 500 includes steps 510–534 of generating metadata tags for knowledge base files (step 510), extracting entities from knowledge base files (step 512), generating relationships for the extracted entities (step 514), storing metadata, entity, and relationship information for each file (step 516), identifying task-specific metadata tags (step 518), generating a new task-specific knowledge graph (step 320), storing the task specific knowledge graph (step 522), determining whether knowledge graphs have been generated for all tasks (step 524), receiving a written description of a new task (step 526), generating query metadata (step 528), determining whether to use an existing knowledge graph (step 529), retrieving a relevant task-specific knowledge graph (step 530), generating a new knowledge graph (step 531), interrogating the retrieved knowledge graph (step 332), and performing language generation (step 534). Method 300 is discussed generally herein with reference to system 10 (FIG. 1) for clarity and explanatory convenience, but can be performed by any suitable system, including, e.g., system 200 (FIG. 2). Steps 510–524 collectively form graph generation steps 540. Similarly, steps 526–334 collectively form on-demand retrieval/generation steps 550.

Method 500 is similar to method 300 and includes graph generation steps 540 which pre-generate knowledge graphs for known or expected worker tasks. However, and as will be explained in more detail subsequently, method 500 also includes steps that allow server 100 to generate a new knowledge graph in examples where no existing knowledge graph sufficiently relates to a new task.

Steps 510, 512, 514, 516, 518, 520, 522, and 524 are substantially similar to steps 310, 312, 314, 316, 318, 320, 322, and 324 of method 300 (FIG. 3), respectively, and the descriptions herein of steps 310, 312, 314, 316, 318, 320, 322, and 324 are applicable to steps 510, 512, 514, 516, 518, 520, 522, and 524, respectively. Steps 510–524 generate knowledge graphs for a known, existing, expected, etc. set of tasks and can be repeated on scheduled intervals to update the pre-existing knowledge graphs stored to knowledge graph database 160, as described previously with respect to graph generation steps 340 of method 300 (FIG. 3).

Steps 526 and 528 are substantially similar to steps 326 and 328 of method 300 (FIG. 3), respectively, and the descriptions of steps 326 and 328 herein are applicable to steps 526 and 528, respectively.

In step 529, server 100 determines whether to use an existing knowledge graph stored to knowledge graph database 160. Server 100 can determine whether to use an existing knowledge graph database 160 by, for example, comparing the task-specific metadata tags generated in step 526 with the task-specific metadata tags stored to knowledge graph database 160. In at least some examples, metadata tag comparison can be performed by assessing semantic similarity, such as by a vector comparison, as described elsewhere herein (e.g., the discussion of entity and relationship generation module 120; FIG. 1). If the task-specific metadata tags generated in step 526 are sufficiently similar to task-specific metadata tags of a task-specific knowledge graph (i.e., have a similarity above a threshold value), method 500 proceeds to step 530. If the task-specific metadata tags generated in step 526 are not sufficiently similar to task-specific metadata tags of any task-specific knowledge graphs of knowledge graph database 160 (i.e., do not have similarity above the threshold value to the metadata tags of any pre-generated knowledge graph), method 500 proceeds to step 531.

In step 530, the graph identified in step 529 is retrieved from knowledge graph database 160. The graph can then be used in subsequent step 532.

In step 531, a new knowledge graph is generated. The knowledge graph is generated in the same manner as the knowledge graphs generated in step 520 and as described previously with respect to the discussion of step 320 of method 300. In particular, the metadata tags generated in step 526 are used to identify files (of knowledge base 170) having sufficiently similar metadata tags according to the metadata tags generated in step 510 and stored in step 516. The entities and relationships for those files (i.e., generated in steps 512 and 514, respectively, and subsequently stored in step 516) can then be used to construct a new task-specific knowledge graph. The new task-specific knowledge graph can optionally be stored to knowledge graph database 170 in the same manner as knowledge graphs were stored in step 522 and as described previously with respect to step 322 of method 300 (FIG. 3).

Step 532 and 534 are optional steps of method 500 and of on-demand retrieval/generation steps 550. In some examples, method 500 stops after step 530 or step 531 (i.e., according to the determination made in step 529), and only the relevant knowledge graph is provided to the user. The user can then interact with the knowledge graph (e.g., with a visual depiction thereof) to identify files relevant to performing the task.

In step 532, the knowledge graph retrieved in step 530 or generated in step 531 (i.e., according to the determination made in step 529) is interrogated using the description of the task received in step 526 to identify files relevant to the described task.

In step 534, language generation is performed. Step 534 is sufficiently similar to step 334 of method 300 (FIG. 3), and the description herein of step 334 is applicable to step 534 of method 500.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of task-specific language generation, the method comprising:
receiving a knowledge base containing a plurality of documents;
generating a plurality of metadata tags describing content of a plurality of documents using a first machine-learning language model;
extracting at least one entity from each document of the plurality of documents, thereby extracting a plurality of entities;
generating a plurality of relationships between the plurality of entities;
receiving a plurality of sets of task-specific metadata tags;
generating a plurality of task-specific knowledge graphs and a plurality of corresponding subsets of metadata tags by, for each set of task-specific metadata tags:
identifying task-specific documents of the plurality of documents using the set of task-specific metadata tags and the plurality of metadata tags;
retrieving a subset of entities of the plurality of entities extracted from the task-specific documents;
retrieving a subset of relationships from the plurality of relationships, the subset of relationships connecting the subset of entities; and
generating one task-specific knowledge graph based on the subset of entities and the subset of relationships; and
generating one subset of metadata tags of the plurality of subset of metadata tags, the one subset of metadata tags including all metadata tags of the plurality of metadata tags derived from the task-specific documents;
storing the plurality of task-specific knowledge graphs and the plurality of subsets of metadata tags to a knowledge graph database;
receiving a set of query tags based on a description of a new task;
querying the knowledge graph database with the set of query tags to identify a task-relevant knowledge graph of the plurality of knowledge graphs;
retrieving relevant documents of the plurality of documents by interrogating the relevant knowledge graph with the description of the new task; and
generating a written plan for performing the new task using a task-handling machine-learning model and based on the relevant documents and the description of the new task.

2. The method of claim 1, wherein:
the knowledge base is an insurance claims knowledge base;
the new task is a new insurance claim;
the relevant documents include at least one of an insurance policy belonging to the customer that filed the new insurance claim, a law relevant to the insurance claim, a relevant medical record, an incident report for the new insurance claim, and a prior claim record for the customer that filed the new insurance claim; and
the written plan is for processing the new insurance claim.

3. A method of automatedly extracting task-specific information from a knowledge base, the method comprising:
generating a plurality of metadata tags describing content of a plurality of documents using a first machine-learning language model;
extracting at least one entity from each document of the plurality of documents, thereby extracting a plurality of entities;
generating a plurality of relationships between the plurality of entities;
assembling a set of task-specific metadata tags;
identifying task-specific documents of the plurality of documents using the task-specific metadata tags and the plurality of metadata tags;
defining a subset of the plurality of entities extracted from the task-specific documents as task-relevant entities;
retrieving a subset of relationships from the plurality of relationships, the subset of relationships connecting the task-relevant entities; and
generating a task-specific knowledge graph based on the task-relevant entities and the subset of relationships.

4. The method of claim 3, and further comprising:
storing the task-specific knowledge graph and a subset of metadata tags of the plurality of metadata tags derived from the task-specific documents to a knowledge graph database, the knowledge graph database storing a plurality of task-specific knowledge graphs and a plurality of corresponding subsets of metadata tags;
after storing the task-specific knowledge graph and the subset of metadata tags, generating a set of query tags based on a description of a new task;
querying the knowledge graph database with the set of query tags to identify a relevant knowledge graph within the plurality of knowledge graphs; and
retrieving relevant documents of the plurality of documents by interrogating the relevant knowledge graph with the description of the new task.

5. The method of claim 4, and further comprising:
generating a prompt for a task-handling machine-learning model including the relevant documents, the description of the new task, and an instruction to generate a written plan for performing the new task; and
providing the prompt to the task-handling machine-learning model to generate the written plan.

6. The method of claim 5, wherein the task-handling machine-learning model is the first machine-learning model.

7. The method of claim 5, and further comprising:
assigning the new task to a user account; and
changing permissions for the relevant documents of the plurality of documents to enable the user account to access the relevant documents of the plurality of documents.

8. The method of claim 5, wherein generating the plurality of relationships between the plurality of entities comprises:
generating vector embeddings representative of each document of the plurality of documents, thereby generating a plurality of vector embeddings representative of the plurality of documents;
performing a pairwise comparison of all vector embeddings of the plurality of vector embeddings to identify a plurality of pairs of vector embeddings having a similarity above a similarity threshold; and
for each pair of the plurality of pairs, relating corresponding documents of the plurality of documents, thereby generating the plurality of relationships.

9. The method of claim 8, wherein the metadata tags for each document describe at least two of a task the document is likely to be relevant to, a legal jurisdiction to which the document applies, and a law described by the document.

10. The method of claim 9, wherein generating the plurality of metadata tags comprises, for each document of the plurality of documents, generating at least one metadata tag by prompting the machine-learning language model to generate a natural-language phrase descriptive of at least one of a task the document is likely to be relevant to, a legal jurisdiction to which the document applies, and a law described by the document.

11. The method of claim 10, wherein the knowledge base is an insurance claims knowledge base.

12. The method of claim 3, wherein each document of the plurality of documents is a single chunk of a parent document, such that the plurality of documents is a plurality of chunks derived from a plurality of parent documents.

13. The method of claim 12, wherein the knowledge graph contains a plurality of nodes and each node of the plurality of nodes corresponds to an entity of task-relevant entities.

14. The method of claim 13, wherein all nodes of the plurality of nodes correspond to unique entities of the task-relevant entities.

15. The method of claim 14, wherein each node of the plurality of nodes are linked to at least one chunk of the plurality of chunks from which a respective entity of the task-relevant entities represented by the node was extracted.

16. A system for automatedly extracting task-specific information from a knowledge base, the system comprising:
a processor; and
at least one memory encoded with instructions that, when executed, cause the processor to:
generate a plurality of metadata tags describing content of a plurality of documents using a first machine-learning language model;
extract at least one entity from each document of the plurality of documents, thereby extracting a plurality of entities;
generate a plurality of relationships between the plurality of entities;
assemble a set of task-specific metadata tags;
identify task-specific documents of the plurality of documents using the task-specific metadata tags and the plurality of metadata tags;
define a subset of the plurality of entities extracted from the task-specific documents as task-relevant entities;
retrieve a subset of relationships from the plurality of relationships, the subset of relationships connecting the task-relevant entities; and
generate a task-specific knowledge graph based on the task-relevant entities and the subset of relationships.

17. The system of claim 16, wherein the instructions, when executed, further cause the processor to:
store the task-specific knowledge graph and a subset of metadata tags of the plurality of metadata tags derived from the task-specific documents to a knowledge graph database, the knowledge graph database storing a plurality of task-specific knowledge graphs and a plurality of corresponding subsets of metadata tags;
after storing the task-specific knowledge graph and the subset of metadata tags, generate a set of query tags based on a description of a new task;
query the knowledge graph database with the set of query tags to identify a relevant knowledge graph within the plurality of knowledge graphs; and
retrieve relevant documents of the plurality of documents by interrogating the relevant knowledge graph with the description of the new task.

18. The system of claim 17, wherein the instructions, when executed, further cause the processor to:
generate a prompt for a task-handling machine-learning model including the relevant documents, the description of the new task, and an instruction to generate a written plan for performing the new task; and
provide the prompt to the task-handling machine-learning model to generate the written plan.

19. The system of claim 18, wherein the task-handling machine-learning model is the first machine-learning model.

20. The system of claim 18, wherein the instructions, when executed, further cause the processor to:
assigning the new task to a user account; and
changing permissions for the relevant documents of the plurality of documents to enable the user account to access the relevant documents of the plurality of documents.
